(19) United States
(12) Patent Application Publication
(10) Pub. No.: US 2025/0055720 A1
(43) Pub. Date: Feb. 13, 2025

(54) UNSUPPORTED BROADCAST TRANSMISSION

(71) Applicant: Nokia Technologies Oy, Espoo (FI)

(72) Inventors: Horst Thomas BELLING, Munich (DE); Philippe GODIN, Massy (FR); Ugur Baran ELMALI, Munich (DE)

(21) Appl. No.: 18/797,862

(22) Filed: Aug. 8, 2024

Related U.S. Application Data
(60) Provisional application No. 63/519,048, filed on Aug. 11, 2023.

(51) Int. Cl. H04L 12/18

(52) U.S. Cl. CPC H04L 12/1845; H04L 12/189

(57) ABSTRACT

Methods, computer program products, and apparatus are provided for communicating information regarding support of broadcast transmission in a requested multicast and broadcast services (MBS) service area. An access and mobility function (AMF), application function (AF), network repository function (NRF), network exposure function (NEF), multicast and broadcast session management function (MB-SMF), or a network repository function (NRF) may communicate or receive communication relating to support of MBS broadcast transmission in a requested MBS service area.

### CROSS-REFERENCE TO RELATED APPLICATIONS

This application claims the benefit of priority of U.S. Provisional Patent Application No. 63/519,048 filed Aug. 11, 2023, which is hereby incorporated by reference.

### TECHNOLOGICAL FIELD

An example embodiment relates generally to communication systems and, more particularly, but not exclusively, to apparatuses, method, and computer programs for a communications system.

### BACKGROUND

A communication system can be seen as a facility that enables communications between two or more communication devices or provides communication devices access to a data network. A communication system may operate in accordance with standards such as those provided by 3GPP (Third Generation Partnership Project) or ETSI (European Telecommunications Standards Institute). Examples of standards are the so-called 5G (5th Generation) standards provided by 3GPP. Previous 3rd Generation Partnership Project (3GPP) releases of Fifth Generation Core network (5GC) have defined some standards relating to multicast and broadcast services (MBS).

### BRIEF SUMMARY

3GPP provides support of multicast and broadcast services (MBS) to facilitate concurrent transmission of data to a plurality of receiving devices, such as user equipment (UE). In at least some versions of 3GPP, a session for a multicast and broadcast session management function (MB-SMF) assigned to an MBS session cannot be changed while the session is ongoing. When an application function (AF) requests MBS service areas not covered by a single MB-SMF service area, an error scenario may occur. Additionally, for MBS broadcast, an MBS service area may not be supported if some radio access network (RAN) nodes within the MBS service area do not support MBS broadcast service. This is different to MBS multicast service, where a fallback mechanism has been defined to use “individual delivery” towards RAN nodes not supporting MBS multicast. Thus, restrictions due to lacking RAN node MBS broadcast support are not expected to be reflected in the MB-SMF service area registered in the network repository function (NRF).

3GPP Technical Specification (TS) 23.247 describes the procedures for MBS Session Start for Broadcast, MBS Session Delivery Status Indication for Broadcast, and Group Message Delivery via MBS Broadcast.

However, some RAN nodes may not support Fifth Generation MBS (5MBS) and/or MBS broadcast services, and accordingly, such information is not transparent to or provided to the AF, for constructing an MBS broadcast service area. Without such information, the AF cannot deliver the broadcast service to the user equipment (UE) s that reside in sub-areas and/or cells where the RAN nodes do not support 5MBS broadcast services. Or in other words, without such information, AF cannot construct a proper MBS broadcast service area, which in turn leads to UEs not being able to receive a broadcast service.

To address at least some of the above described problems, according to example embodiments disclosed herein, the AF acting as data source for 5MBS broadcast data may be informed about cells where MBS broadcast is not supported to enable the AF to deliver data to UEs residing in those cells via alternative methods, such as but not limited to unicast transmission. This applies in particular for public safety, where the AF is aware of UE locations. Additionally or alternatively, the AF may use the information to decide to use MBS multicast instead of MBS broadcast transmission.

Certain example embodiments disclosed herein may facilitate the provision of such information to the AF in a variety of ways. When establishing an MBS multicast session, the AF may subscribe at the MB-SMF to notifications about sub-areas of the requested MBS service area where MBS broadcast transmission is supported and/or not supported, and/or whether MBS broadcast transmission is supported and/or not supported in the entire requested MBS service area.

As referenced herein, a part of a requested service area, a sub-area and/or an area may be indicated by, defined by, received as, stored as, and/or the like in a variety of ways, including using or referencing any data or information identifying any number of cells and/or tracking areas (TA) s of an MBS service area. For example, the sub-area or area may be indicated by a cell identifier, cell identifier list, tracking area identity (TAI), and/or a tracking area codes (TAC). In this regard, a sub-area or area may be indicated by, defined by, received as, and/or stored as a set of any of the aforementioned identifying information such as but not limited to cell identifiers, tracking area identifiers, and/or the like.

Based on this subscription, when the MB-SMF sends request to start or update the MBS broadcast session to an application management function (AMF), the MB-SMF may include an indication requesting to be informed about sub-areas of the requested MBS service area where MBS broadcast transmission is supported and/or not supported, and/or whether MBS broadcast transmission is supported and/or not supported in the entire requested MBS service area.

When the AMF handles a request from the MB-SMF to start an MBS broadcast session within a service area or to update the MBS session with an enlarged/changed service area, the AMF checks whether the NG-RAN nodes handling the parts, or sub-areas, of the MBS session service area controlled by the AMF support MBS broadcast.

If one or more sub-areas of the service area controlled by the AMF are handled by NG-RAN nodes not supporting 5MBS, the AMF informs the MB-SMF about sub-areas of the requested MBS service area where MBS broadcast transmission is supported and/or not supported, and/or whether MBS broadcast transmission is supported and/or not supported in the entire requested MBS service area.

According to certain embodiments disclosed herein, the MB-SMF checks replies from AMFs it contacted for the start or update of the MBS broadcast session, and if any AMF indicated that the MBS broadcast session is not supported in sub-areas of the requested MBS service area, it combines the areas where the MBS broadcast service is supported and/or not supported indicated by the different AMFs. The AMF sends a notification towards the AF and/or MB-SMF about sub-areas of the requested MBS service area where MBS broadcast transmission is supported and/or not supported, and/or whether MBS broadcast transmission is supported and/or not supported in the entire requested MBS service area.

Accordingly, when receiving the notification, the AMF may identify UEs that subscribed to the MBS session and are residing in parts, or sub-areas, of the MBS service area where MBS broadcast is not supported, and send data related to the MBS session via an alternative method, such as but not limited to unicast delivery, to those UEs. According to certain embodiments, the AF may terminate the MBS broadcast session and establish an MBS multicast session instead of the MBS broadcast session.

According to certain embodiments, NEF/MBSF and/or MB-SMF compares MBS service area received in an MBS session create or modification request for an MBS broadcast session from an AF with configured information about areas where MBS broadcast is supported in the RAN. If the MBS service area includes one or more sub-areas where MBS broadcast is not supported, the NEF/MBSF and/or MB-SMF indicates in the reply to the MBS session create or modification request information about sub-areas of the requested MBS service area where MBS broadcast transmission is supported and/or not supported, and/or whether MBS broadcast transmission is supported and/or not supported in the entire requested MBS service area.

The reply can either be an error response rejecting the MBS session create or modification and indicating as cause for the rejection that MBS broadcast is not supported in parts, or sub-areas, of the service area, or an acceptance of the MBS session create or modification request.

In certain embodiments, the MB-SMF stores in its profile at the NRF information about an area that the MB-SMF serves where MBS broadcast is supported, and the NEF/MBSF retrieves this information and uses it during the MBS broadcast session creation to select the MB-SMF serving the requested MBS service area and to check whether MBS broadcast is supported in the requested MBS service area.

When receiving the reply, the AF may identify UEs that subscribed to the MBS session and are residing in parts, or sub-areas, of the MBS service area where MBS broadcast is not supported, and send data related to the MBS session via unicast delivery to those UEs. Alternatively, the AF may terminate the MBS broadcast session and establish an MBS multicast session instead of the MBS broadcast session. If the reply was a rejection, the AF can also send a new MBS session create or modification request with a service area reduced to the parts, or sub-areas, where MBS broadcast is supported.

An apparatus is provided comprising at least one processor, at least one memory comprising instructions for an access and mobility management function (AMF), wherein the instructions, when executed by the at least one processor, cause the apparatus to at least determine that multicast and broadcast services (MBS) broadcast transmission is not supported in at least one sub-area of a requested MBS service area, and in response to the determining, provide, toward a multicast and broadcast session management function (MB-SMF), at least one of the following: the at least one sub-area of the requested MBS service area in which MBS broadcast transmission is not supported, at least one sub-area of the requested MBS service area in which MBS broadcast transmission is supported, an indication that MBS broadcast transmission is not supported in at least one sub-area of the requested MBS service area, or an indication that MBS broadcast transmission is not supported in an entirety of the requested MBS service area.

The instructions, when executed by the at least one processor, further cause the apparatus to at least receive, from the MB-SMF, an MBS session start request comprising a request for information regarding the support of MBS broadcast transmission in the MBS service area, wherein the determining and the providing is performed in response thereto.

The instructions, when executed by the at least one processor, further cause the apparatus to at least receive, from a next generation radio access network (NG-RAN) node, an MBS capability indicator, and store the MBS capability indicator in association with at least one of: an identifier of the NG-RAN node, an area served by the NG-RAN node, or an area comprising the area served by the NG-RAN node, wherein the determining is based on at least the MBS capability indicator.

According to certain embodiments, the determining comprises sending a request to an NG-RAN node to start MBS broadcast transmission or setup a broadcast context, receiving a response to the request, the response comprising an error indicating that at least one of MBS broadcast transmission or the setup of the broadcast context is not supported, and storing an indication that MBS broadcast transmission is not supported, in association with at least one of an identifier of the NG-RAN node, an area served by the NG-RAN node, or an area comprising the area served by the NG-RAN node.

The determining comprises receiving, from an Operations, Administration and Maintenance (OAM) system, one or more configurations for MBS broadcast transmission, the one or more configurations for MBS broadcast transmission indicating at least one of whether an NG-RAN node supports MBS broadcast transmission, an area in which MBS broadcast transmission is supported, an area in which broadcast transmission is not supported, or information about an area served by an NG-RAN node, and storing the one or more configurations, wherein the determination is based at least on the one or more configurations.

The determining may further include, based on the stored one or more configurations for MBS broadcast transmission, comparing an area served by the one or more NG-RAN nodes associated with the requested MBS service area, and determining whether or not MBS broadcast transmission is supported by the one or more NG-RAN nodes.

According to certain embodiments, the determining further comprises determining a first set of NG-RAN node IDs corresponding to NG-RAN node serving cells of the requested MBS service area deriving a second set of NG-RAN node IDs corresponding to at least one of: the NG-RAN nodes of the first set which do not support MBS broadcast transmission according to stored information, or the NG-RAN nodes of the first set which support the MBS broadcast transmission according to stored information; and performing at least one of determining the at least one sub-area of the requested MBS service area in which the MBS broadcast transmission is not supported from the second set of NG-RAN nodes which do not support MBS broadcast transmission; or determining the at least one sub-area of the requested MBS service area in which the MBS broadcast transmission is supported from the second set of NG-RAN nodes which support MBS broadcast transmission.

According to certain embodiments, the determining further comprises performing at least one of determining a NG-RAN node ID of the first set by taking a predetermined number of leftmost bits of cell IDs of cells comprised in the requested MBS service area, determining the at least one sub-area of the requested MBS service area in which the MBS broadcast transmission is not supported by identifying the cells for which the cell ID has the predetermined number of leftmost bits corresponding to one of the NG-RAN node IDs of the second set of NG-RAN node IDs, or determining the at least one sub-area of the requested MBS service area in which the MBS broadcast transmission is supported by identifying the cells for which the cell ID has the predetermined number of leftmost bits corresponding to one of the NG-RAN node IDs of the second set of NG-RAN node IDs.

A method is provided for an access and mobility management function (AMF), the method comprising determining that multicast and broadcast services (MBS) broadcast transmission is not supported in at least one sub-area of a requested MBS service area, and in response to the determining, providing, toward a multicast and broadcast session management function (MB-SMF), at least one of the following: the at least one sub-area of the requested MBS service area in which MBS broadcast transmission is not supported, at least one sub-area of the requested MBS service area in which MBS broadcast transmission is supported, an indication that MBS broadcast transmission is not supported in at least one sub-area of the requested MBS service area, or an indication that MBS broadcast transmission is not supported in an entirety of the requested MBS service area.

The method may further include receiving, from the MB-SMF, an MBS session start request comprising a request for information regarding the support of MBS broadcast transmission in the MBS service area, wherein the determining and the providing is performed in response thereto.

The method further includes, receiving, from a next generation radio access network (NG-RAN) node, an MBS capability indicator, and storing the MBS capability indicator in association with at least one of: an identifier of the NG-RAN node, an area served by the NG-RAN node, or an area comprising the area served by the NG-RAN node, wherein the determining is based on at least the MBS capability indicator.

A computer program product is provided, comprising at least one non-transitory computer-readable storage medium including one or more sequences of one or more instructions which, when executed by one or more processors, cause an apparatus to at least perform at least the following determine that multicast and broadcast services (MBS) broadcast transmission is not supported in at least one sub-area of a requested MBS service area, and in response to the determining, provide, toward a multicast and broadcast session management function (MB-SMF), at least one of the following: the at least one sub-area of the requested MBS service area in which MBS broadcast transmission is not supported, at least one sub-area of the requested MBS service area in which MBS broadcast transmission is supported, an indication that MBS broadcast transmission is not supported in at least one sub-area of the requested MBS service area, or an indication that MBS broadcast transmission is not supported in an entirety of the requested MBS service area.

The computer-executable program code instructions further comprise program code instructions to receive, from the MB-SMF, an MBS session start request comprising a request for information regarding the support of MBS broadcast transmission in the MBS service area, wherein the determining and the providing is performed in response thereto.

The computer-executable program code instructions further comprise program code instructions to receive, from a next generation radio access network (NG-RAN) node, an MBS capability indicator, and store the MBS capability indicator in association with at least one of: an identifier of the NG-RAN node, an area served by the NG-RAN node, or an area comprising the area served by the NG-RAN node, wherein the determining is based on at least the MBS capability indicator.

An apparatus comprising means for determining that multicast and broadcast services (MBS) broadcast transmission is not supported in at least one sub-area of a requested MBS service area, and means for providing, in response to the determining, toward a multicast and broadcast session management function (MB-SMF), at least one of the following: the at least one sub-area of the requested MBS service area in which MBS broadcast transmission is not supported, at least one sub-area of the requested MBS service area in which MBS broadcast transmission is supported, an indication that MBS broadcast transmission is not supported in at least one sub-area of the requested MBS service area, or an indication that MBS broadcast transmission is not supported in an entirety of the requested MBS service area.

The apparatus further includes means for receiving, from the MB-SMF, an MBS session start request comprising a request for information regarding the support of MBS broadcast transmission in the MBS service area, wherein the determining and the providing is performed in response thereto. The apparatus further includes means for receiving, from a next generation radio access network (NG-RAN) node, an MBS capability indicator, and means for storing the MBS capability indicator in association with at least one of: an identifier of the NG-RAN node, an area served by the NG-RAN node, or an area comprising the area served by the NG-RAN node, wherein the determining is based on at least the MBS capability indicator. The means for determining further comprises means for sending a request to an NG-RAN node to start MBS broadcast transmission or setup a broadcast context, means for receiving a response to the request, the response comprising an error indicating that at least one of MBS broadcast transmission or the setup of the broadcast context is not supported, and means for storing an indication that MBS broadcast transmission is not supported, in association with at least one of an identifier of the NG-RAN node, an area served by the NG-RAN node, or an area comprising the area served by the NG-RAN node.

The means for determining may further include means for receiving, from an Operations, Administration and Maintenance (OAM) system, one or more configurations for MBS broadcast transmission, the one or more configurations for MBS broadcast transmission indicating at least one of whether an NG-RAN node supports MBS broadcast transmission, an area in which MBS broadcast transmission is supported, an area in which broadcast transmission is not supported, or information about an area served by an NG-RAN node, and means for storing the one or more configurations, wherein the determination is based at least on the one or more configurations.

The means for determining further comprises means for comparing, based on the stored one or more configurations for MBS broadcast transmission, an area served by the one or more NG-RAN nodes associated with the requested MBS service area, and means for determining whether or not MBS broadcast transmission is supported by the one or more NG-RAN nodes.

The means for determining further comprises means for determining a first set of NG-RAN node IDs corresponding to NG-RAN node serving cells of the requested MBS service area, means for deriving a second set of NG-RAN node IDs corresponding to at least one of: the NG-RAN nodes of the first set which do not support MBS broadcast transmission according to stored information, or the NG-RAN nodes of the first set which support the MBS broadcast transmission according to stored information; and means for performing at least one of determining the at least one sub-area of the requested MBS service area in which the MBS broadcast transmission is not supported from the second set of NG-RAN nodes which do not support MBS broadcast transmission, or means for determining the at least one sub-area of the requested MBS service area in which the MBS broadcast transmission is supported from the second set of NG-RAN nodes which support MBS broadcast transmission.

The means for determining further comprises means for determining a NG-RAN node ID of the first set by taking a predetermined number of leftmost bits of cell IDs of cells comprised in the requested MBS service area, means for determining the at least one sub-area of the requested MBS service area in which the MBS broadcast transmission is not supported by identifying the cells for which the cell ID has the predetermined number of leftmost bits corresponding to one of the NG-RAN node IDs of the second set of NG-RAN node IDs, or means for determining the at least one sub-area of the requested MBS service area in which the MBS broadcast transmission is supported by identifying the cells for which the cell ID has the predetermined number of leftmost bits corresponding to one of the NG-RAN node IDs of the second set of NG-RAN node IDs.

An apparatus is provided, comprising at least one processor, at least one memory comprising instructions for an application function (AF), when executed by the at least one processor, cause the apparatus to at least send a request to create or update a multicast and broadcast services (MBS) broadcast session, or to allocate an MBS session identifier toward at least one of a network exposure function (NEF), a multicast and broadcast session management function (MB-SMF) or a multicast and broadcast service function (MBSF), the request comprising a requested MBS service area for the MBS broadcast session, receive a message indicating at least one of the following: MBS broadcast transmission is not supported in the entire requested MBS service area, MBS broadcast transmission is not supported in at least one sub-area of the requested MBS service area, at least one sub-area of the requested MBS service area in which MBS broadcast transmission is supported, or at least one sub-area of the requested MBS service area in which MBS broadcast transmission is not supported, receive (a) information about at least one user equipment (UE) desiring to receive the MBS broadcast session, and (b) a UE location of the at least one UE, based on the received message and the UE location of the at least one UE, identify one or more second UE located in at least one sub-area of the requested MBS service area in which MBS broadcast transmission is not supported, and send data toward the one or more second UE via unicast communication. The data that is sent via unicast communication is transmitted as MBS data in the one or more sub-areas of the requested MBS sub-area in which MBS broadcast transmission is supported.

According to certain embodiments, based on the received message, the apparatus performs at least one of the following: identify one or more second UE located in at least one sub-area of the requested MBS service area in which MBS broadcast transmission is not supported, send data toward the one or more second UE via unicast communication, send an MBS broadcast session creation request with an MBS service area excluding the one or more sub-areas of the requested MBS service area in which MBS broadcast is not supported, terminate the MBS broadcast session associated with the one or more sub-areas of the requested MBS service area in which MBS broadcast transmission is not supported, send an MBS broadcast session update request with an MBS service area excluding the one or more sub-areas of the requested MBS service area in which MBS broadcast is not supported, or initiate an MBS multicast session.

The received message may be a response to the request sent to create or update an MBS broadcast session from the at least one of the NEF, the MB-SMF or the MBSF.

The instructions, when executed by the at least one processor, further cause the apparatus to at least send an MBS broadcast session creation request with an MBS service area excluding the one or more sub-areas of the requested MBS service area in which MBS broadcast is not supported.

The instructions, when executed by the at least one processor, further cause the apparatus to at least terminate an MBS broadcast session associated with the one or more sub-areas of the requested MBS service area in which MBS broadcast transmission is not supported.

The instructions, when executed by the at least one processor, further cause the apparatus to at least send an MBS broadcast session update request with an MBS service area excluding the one or more sub-areas of the requested MBS service area in which MBS broadcast is not supported.

The the instructions, when executed by the at least one processor, further cause the apparatus to at least initiate a multicast session comprising a multicast service area which comprises the at least one sub-area of the requested MBS service area in which the MBS broadcast transmission is not supported.

A method is provided, comprising sending a request to create or update a multicast and broadcast services (MBS) broadcast session, or to allocate an MBS session identifier toward at least one of a network exposure function (NEF), a multicast and broadcast session management function (MB-SMF) or a multicast and broadcast service function (MBSF), the request comprising a requested MBS service area for the MBS broadcast session, receiving a message indicating at least one of the following: MBS broadcast transmission is not supported in the entire requested MBS service area, MBS broadcast transmission is not supported in at least one sub-area of the requested MBS service area, at least one sub-area of the requested MBS service area in which MBS broadcast transmission is supported, or at least one sub-area of the requested MBS service area in which MBS broadcast transmission is not supported, receiving (a) information about at least one user equipment (UE) desiring to receive the MBS broadcast session, and (b) a UE location of the at least one UE, based on the received message and the UE location of the at least one UE, identifying one or more second UE located in at least one sub-area of the requested MBS service area in which MBS broadcast transmission is not supported, and sending data toward the one or more second UE via unicast communication. The data that is sent via unicast communication may be transmitted as MBS data in the one or more sub-areas of the requested MBS sub-area in which MBS broadcast transmission is supported.

A computer program product is provided, comprising at least one non-transitory computer-readable storage medium including one or more sequences of one or more instructions which, when executed by one or more processors, cause an apparatus to at least perform at least the following send a request to create or update a multicast and broadcast services (MBS) broadcast session, or to allocate an MBS session identifier toward at least one of a network exposure function (NEF), a multicast and broadcast session management function (MB-SMF) or a multicast and broadcast service function (MBSF), the request comprising a requested MBS service area for the MBS broadcast session, receive a message indicating at least one of the following: MBS broadcast transmission is not supported in the entire requested MBS service area, MBS broadcast transmission is not supported in at least one sub-area of the requested MBS service area, at least one sub-area of the requested MBS service area in which MBS broadcast transmission is supported, or at least one sub-area of the requested MBS service area in which MBS broadcast transmission is not supported, receive (a) information about at least one user equipment (UE) desiring to receive the MBS broadcast session, and (b) a UE location of the at least one UE, based on the received message and the UE location of the at least one UE, identify one or more second UE located in at least one sub-area of the requested MBS service area in which MBS broadcast transmission is not supported, and send data toward the one or more second UE via unicast communication.

The data that is sent via unicast communication is transmitted as MBS data in the one or more sub-areas of the requested MBS sub-area in which MBS broadcast transmission is supported. The received message is a notification message; and wherein the computer-executable program code instructions further comprise program code instructions to subscribe for information regarding the support of MBS broadcast transmission in the MBS service area.

An apparatus is provided comprising means for sending a request to create or update a multicast and broadcast services (MBS) broadcast session, or to allocate an MBS session identifier toward at least one of a network exposure function (NEF), a multicast and broadcast session management function (MB-SMF) or a multicast and broadcast service function (MBSF), the request comprising a requested MBS service area for the MBS broadcast session, means for receiving a message indicating at least one of the following: MBS broadcast transmission is not supported in the entire requested MBS service area, MBS broadcast transmission is not supported in at least one sub-area of the requested MBS service area, at least one sub-area of the requested MBS service area in which MBS broadcast transmission is supported, or at least one sub-area of the requested MBS service area in which MBS broadcast transmission is not supported, means for receiving (a) information about at least one user equipment (UE) desiring to receive the MBS broadcast session, and (b) a UE location of the at least one UE, means for identifying, based on the received message and the UE location of the at least one UE, one or more second UE located in at least one sub-area of the requested MBS service area in which MBS broadcast transmission is not supported, and means for sending data toward the one or more second UE via unicast communication.

An apparatus is provided comprising at least one processor, at least one memory comprising instructions for a multicast and broadcast session management function (MB-SMF), when executed by the at least one processor, cause the apparatus to at least receive a request, from at least one of a network repository function (NRF), a network exposure function (NEF), or a multicast and broadcast service function (MBSF), to create or update a multicast and broadcast services (MBS) broadcast session, the request comprising a requested MBS service area, determine, at least one of determine that MBS broadcast transmission is not supported in at least one sub-area of a requested MBS service area, and send a response toward the least one of the network repository function (NRF), the network exposure function (NEF), or the multicast and broadcast service function (MBSF), the response indicating at least one of the following: the at least one sub-area of the requested MBS service area in which MBS broadcast transmission is not supported, at least one sub-area of the requested MBS service area in which MBS broadcast transmission is supported, or an indication that MBS broadcast transmission is not supported in an entirety of the requested MBS service area. The response is sent in response to the request to create or update the MBS broadcast session. The instructions, when executed by the at least one processor, further cause the apparatus to at least: send a request to start or update an MBS broadcast session to an access and mobility management function (AMF), the request comprising a second requested MBS service area, wherein the second requested MBS service area comprises the requested MBS service area or at least one sub-area of the requested MBS service area, receive from the AMF a message indicating at least one of that MBS broadcast transmission is not supported in the entire second requested MBS service area, that MBS broadcast transmission is supported in the entire second requested MBS service area at least one sub-area of the second requested MBS service area where MBS broadcast transmission is supported, or at least one sub-area of the second requested MBS service area where MBS broadcast transmission is not supported, and determine the sub-area of the requested MBS service area where MBS broadcast transmission is not supported using the message received from the AMF.

The apparatus of any of claims 65-68, wherein the instructions, when executed by the at least one processor, further cause the apparatus to at least receive a configuration about at least one of an area where MBS broadcast transmission is supported or an area where MBS broadcast transmission is not supported, wherein the determining that MBS broadcast transmission is not supported in at least one sub-area of a requested MBS service area is based on the configuration.

The instructions, when executed by the at least one processor, further cause the apparatus to at least request a network resource function (NRF) to store within profile information of the apparatus at least one of information about an area served by the apparatus in which MBS broadcast transmission is supported or information about an area served by the apparatus in which MBS broadcast transmission is not supported, wherein the determining that MBS broadcast transmission is not supported in at least one sub-area of a requested MBS service area is based on the configuration.

A method is provided comprising receiving a request, from at least one of a network repository function (NRF), a network exposure function (NEF), or a multicast and broadcast service function (MBSF), to create or update a multicast and broadcast services (MBS) broadcast session, the request comprising a requested MBS service area, determining, at least one of determine that MBS broadcast transmission is not supported in at least one sub-area of a requested MBS service area, and sending a response toward the least one of the network repository function (NRF), the network exposure function (NEF), or the multicast and broadcast service function (MBSF), the response indicating at least one of the following: the at least one sub-area of the requested MBS service area in which MBS broadcast transmission is not supported, at least one sub-area of the requested MBS service area in which MBS broadcast transmission is supported, or an indication that MBS broadcast transmission is not supported in an entirety of the requested MBS service area. The response is sent in response to the request to create or update the MBS broadcast session.

The method may further include sending a request to start or update an MBS broadcast session to an access and mobility management function (AMF), the request comprising a second requested MBS service area, wherein the second requested MBS service area comprises the requested MBS service area or at least one sub-area of the requested MBS service area, receiving from the AMF a message indicating at least one of that MBS broadcast transmission is not supported in the entire second requested MBS service area, that MBS broadcast transmission is supported in the entire second requested MBS service area at least one sub-area of the second requested MBS service area where MBS broadcast transmission is supported, or at least one sub-area of the second requested MBS service area where MBS broadcast transmission is not supported, and
determining the sub-area of the requested MBS service area where MBS broadcast transmission is not supported using the message received from the AMF.

The method may further include receiving a configuration about at least one of an area where MBS broadcast transmission is supported or an area where MBS broadcast transmission is not supported, wherein the determining that MBS broadcast transmission is not supported in at least one sub-area of a requested MBS service area is based on the configuration.

The method may further include requesting a network resource function (NRF) to store within profile information of an apparatus at least one of information about an area served by the apparatus in which MBS broadcast transmission is supported or information about an area served by the apparatus in which MBS broadcast transmission is not supported, wherein the determining that MBS broadcast transmission is not supported in at least one sub-area of a requested MBS service area is based on the configuration.

A computer program product comprising at least one non-transitory computer-readable storage medium including one or more sequences of one or more instructions which, when executed by one or more processors, cause an apparatus to at least perform at least the following receive a request, from at least one of a network repository function (NRF), a network exposure function (NEF), or a multicast and broadcast service function (MBSF), to create or update a multicast and broadcast services (MBS) broadcast session, the request comprising a requested MBS service area, determine, at least one of determine that MBS broadcast transmission is not supported in at least one sub-area of a requested MBS service area, and send a response toward the least one of the network repository function (NRF), the network exposure function (NEF), or the multicast and broadcast service function (MBSF), the response indicating at least one of the following: the at least one sub-area of the requested MBS service area in which MBS broadcast transmission is not supported, at least one sub-area of the requested MBS service area in which MBS broadcast transmission is supported, or an indication that MBS broadcast transmission is not supported in an entirety of the requested MBS service area.

The response is sent in response to the request to create or update the MBS broadcast session. The computer-executable program code instructions further comprise program code instructions to send a request to start or update an MBS broadcast session to an access and mobility management function (AMF), the request comprising a second requested MBS service area, wherein the second requested MBS service area comprises the requested MBS service area or at least one sub-area of the requested MBS service area, receive from the AMF a message indicating at least one of that MBS broadcast transmission is not supported in the entire second requested MBS service area, that MBS broadcast transmission is supported in the entire second requested MBS service area at least one sub-area of the second requested MBS service area where MBS broadcast transmission is supported, or at least one sub-area of the second requested MBS service area where MBS broadcast transmission is not supported, and determine the sub-area of the requested MBS service area where MBS broadcast transmission is not supported using the message received from the AMF.

The computer-executable program code instructions further comprise program code instructions to receive a configuration about at least one of an area where MBS broadcast transmission is supported or an area where MBS broadcast transmission is not supported, wherein the determining that MBS broadcast transmission is not supported in at least one sub-area of a requested MBS service area is based on the configuration.

The computer-executable program code instructions further comprise program code instructions to request a network resource function (NRF) to store within profile information of the apparatus at least one of information about an area served by the apparatus in which MBS broadcast transmission is supported or information about an area served by the apparatus in which MBS broadcast transmission is not supported, wherein the determining that MBS broadcast transmission is not supported in at least one sub-area of a requested MBS service area is based on the configuration.

An apparatus is provided with means for receiving a request, from at least one of a network repository function (NRF), a network exposure function (NEF), or a multicast and broadcast service function (MBSF), to create or update a multicast and broadcast services (MBS) broadcast session, the request comprising a requested MBS service area, means for determining, at least one of determine that MBS broadcast transmission is not supported in at least one sub-area of a requested MBS service area, and means for sending a response toward the least one of the network repository function (NRF), the network exposure function (NEF), or the multicast and broadcast service function (MBSF), the response indicating at least one of the following: the at least one sub-area of the requested MBS service area in which MBS broadcast transmission is not supported, at least one sub-area of the requested MBS service area in which MBS broadcast transmission is supported, or an indication that MBS broadcast transmission is not supported in an entirety of the requested MBS service area.

An apparatus is provided comprising at least one processor, at least one memory comprising instructions for at least one of a network exposure function (NEF) or a multicast and broadcast service function (MBSF), when executed by the at least one processor, cause the apparatus to at least receive a request, from an application function (AF), to create or update a multicast and broadcast services (MBS) broadcast session, the request comprising a requested MBS service area, determine that MBS broadcast transmission is not supported in at least one sub-area of a requested MBS service area, and send a response toward the AF indicating the at least one of the following: the at least one sub-area of the requested MBS service area in which MBS broadcast transmission is not supported, at least one sub-area of the requested MBS service area in which MBS broadcast transmission is supported, or an indication that MBS broadcast transmission is not supported in an entirety of the requested MBS service area.

The response is sent in response to the request to create or update the MBS broadcast session.

The instructions, when executed by the at least one processor, further cause the apparatus to at least retrieve, from a network repository function (NRF), profile information of at least one multicast and broadcast session management function (MB-SMF) comprising at least one of information about an area served by the MB-SMF in which MBS broadcast transmission is supported or information about an area served by the MB-SMF in which MBS broadcast transmission is not supported, wherein the determining is based on the retrieved profile information.

A method is provided comprising receiving a request, from an application function (AF), to create or update a multicast and broadcast services (MBS) broadcast session, the request comprising a requested MBS service area, determining that MBS broadcast transmission is not supported in at least one sub-area of a requested MBS service area, sending a response toward the AF indicating the at least one of the following: the at least one sub-area of the requested MBS service area in which MBS broadcast transmission is not supported, at least one sub-area of the requested MBS service area in which MBS broadcast transmission is supported, or an indication that MBS broadcast transmission is not supported in an entirety of the requested MBS service area.

A computer program product is provided comprising at least one non-transitory computer-readable storage medium including one or more sequences of one or more instructions which, when executed by one or more processors, cause an apparatus to at least perform at least the following receive a request, from an application function (AF), to create or update a multicast and broadcast services (MBS) broadcast session, the request comprising a requested MBS service area, determine that MBS broadcast transmission is not supported in at least one sub-area of a requested MBS service area, send a response toward the AF indicating the at least one of the following: the at least one sub-area of the requested MBS service area in which MBS broadcast transmission is not supported, at least one sub-area of the requested MBS service area in which MBS broadcast transmission is supported, or an indication that MBS broadcast transmission is not supported in an entirety of the requested MBS service area.

The response is sent in response to the request to create or update the MBS broadcast session.

An apparatus is provided with means for receiving a request, from an application function (AF), to create or update a multicast and broadcast services (MBS) broadcast session, the request comprising a requested MBS service area, means for determining that MBS broadcast transmission is not supported in at least one sub-area of a requested MBS service area, means for sending a response toward the AF indicating the at least one of the following: the at least one sub-area of the requested MBS service area in which MBS broadcast transmission is not supported, at least one sub-area of the requested MBS service area in which MBS broadcast transmission is supported, or an indication that MBS broadcast transmission is not supported in an entirety of the requested MBS service area.

An apparatus is provided comprising at least one processor at least one memory comprising instructions for at least one of a network repository function (NRF), when executed by the at least one processor, cause the apparatus to at least receive a request to store within the profile information of a multicast and broadcast session management function (MB-SMF) at least one of the following: information about an area served by the MB-SMF in which multicast and broadcast services (MBS) broadcast transmission is supported or information about an area served by the MB-SMF in which MBS broadcast transmission is not supported, store the profile information comprising at least one of information about the area served by the MB-SMF in which MBS broadcast transmission is supported or information about the area served by the MB-SMF in which MBS broadcast transmission is not supported, receive a request for the retrieval of profile information relating to the MB-SMF, and provide the profile information comprising at least one of information about the area served by the MB-SMF where MBS broadcast transmission is supported or information. about the area served by the MB-SMF where MBS broadcast transmission is not supported.

A method is provided comprising receiving a request to store within the profile information of a multicast and broadcast session management function (MB-SMF) at least one of the following: information about an area served by the MB-SMF in which multicast and broadcast services (MBS) broadcast transmission is supported or information about an area served by the MB-SMF in which MBS broadcast transmission is not supported, storing the profile information comprising at least one of information about the area served by the MB-SMF in which MBS broadcast transmission is supported or information about the area served by the MB-SMF in which MBS broadcast transmission is not supported, receiving a request for the retrieval of profile information relating to the MB-SMF, and providing the profile information comprising at least one of information about the area served by the MB-SMF where MBS broadcast transmission is supported or information. about the area served by the MB-SMF where MBS broadcast transmission is not supported.

A computer program product is provided comprising at least one non-transitory computer-readable storage medium including one or more sequences of one or more instructions which, when executed by one or more processors, cause an apparatus to at least perform at least the following receive a request to store within the profile information of a multicast and broadcast session management function (MB-SMF) at least one of the following: information about an area served by the MB-SMF in which multicast and broadcast services (MBS) broadcast transmission is supported or information about an area served by the MB-SMF in which MBS broadcast transmission is not supported, store the profile information comprising at least one of information about the area served by the MB-SMF in which MBS broadcast transmission is supported or information about the area served by the MB-SMF in which MBS broadcast transmission is not supported, receive a request for the retrieval of profile information relating to the MB-SMF, provide the profile information comprising at least one of information about the area served by the MB-SMF where MBS broadcast transmission is supported or information. about the area served by the MB-SMF where MBS broadcast transmission is not supported.

An apparatus is provided comprising means for receiving a request to store within the profile information of a multicast and broadcast session management function (MB-SMF) at least one of the following: information about an area served by the MB-SMF in which multicast and broadcast services (MBS) broadcast transmission is supported or information about an area served by the MB-SMF in which MBS broadcast transmission is not supported, means for storing the profile information comprising at least one of information about the area served by the MB-SMF in which MBS broadcast transmission is supported or information about the area served by the MB-SMF in which MBS broadcast transmission is not supported, means for receiving a request for the retrieval of profile information relating to the MB-SMF, and means for providing the profile information comprising at least one of information about the area served by the MB-SMF where MBS broadcast transmission is supported or information. about the area served by the MB-SMF where MBS broadcast transmission is not supported.

The above summary is provided merely for purposes of summarizing some example embodiments of the disclosure so as to provide a basic understanding of some aspects of the disclosure. Accordingly, it will be appreciated that the above described example embodiments are merely examples and should not be construed to narrow the scope or spirit of the disclosure in any way. It will be appreciated that the scope of the disclosure encompasses many potential embodiments, some of which will be further described below, in addition to those here summarized.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 is a block diagram of an apparatus that may be specifically configured in accordance with certain example embodiments;

FIG. 2A is a block diagram of showing a mobile network according to an example embodiment;

FIG. 2B is a block diagram showing network functions and interfaces of the mobile network of FIG. 2A, according to certain example embodiments;

FIGS. 3-5 are diagrams of procedures for requesting an MBS broadcast session, according to certain example embodiments;

FIG. 6 illustrates operations that may be performed by an access and mobility function (AMF) according to certain example embodiments;

FIG. 7 illustrates operations that may be performed by an application function (AF) according to certain example embodiments;

FIG. 8 illustrates operations that may be performed by a multicast and broadcast session management function (MB-SMF) according to certain example embodiments;

FIG. 9 illustrates operations that may be performed by at least one of a network exposure function (NEF), or a multicast and broadcast service function (MBSF), according to certain example embodiments; and

FIG. 10 illustrates operations that may be performed by a network repository function (NRF) function according to certain example embodiments.

### DETAILED DESCRIPTION

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with certain embodiments of the present disclosure. Thus, use of any such terms should not be taken to limit the spirit and scope of embodiments of the present disclosure.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device. The evolution of new communication technologies such as Fifth Generation (5G) and Sixth Generation (6G) have improved upon existing technologies such as second generation (2G) technologies, Third Generation (3G) technologies, Fourth Generation (4G) technologies and Long Term Evolution (LTE) technologies and has thus resulted in improved network connectivity.

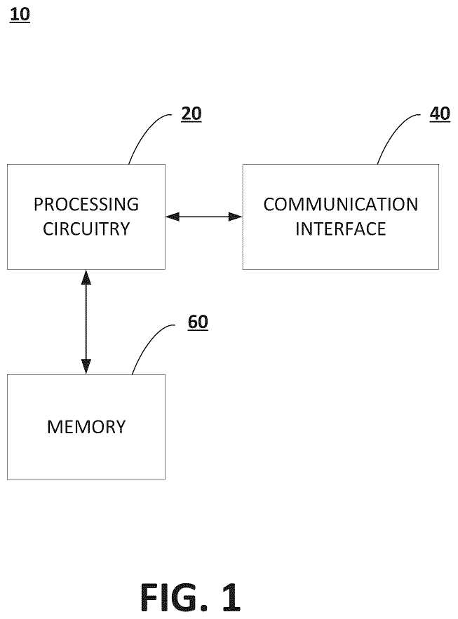

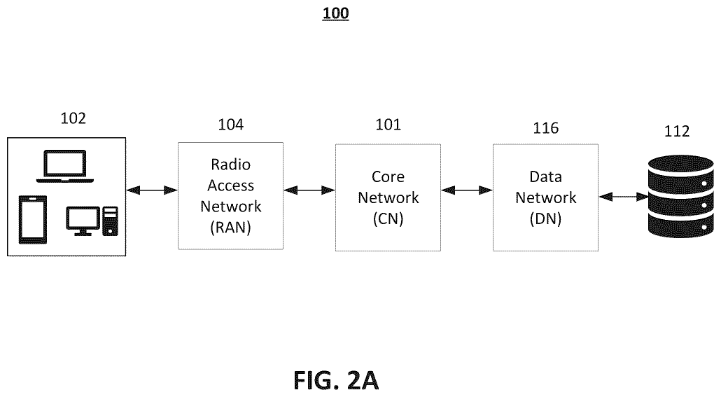

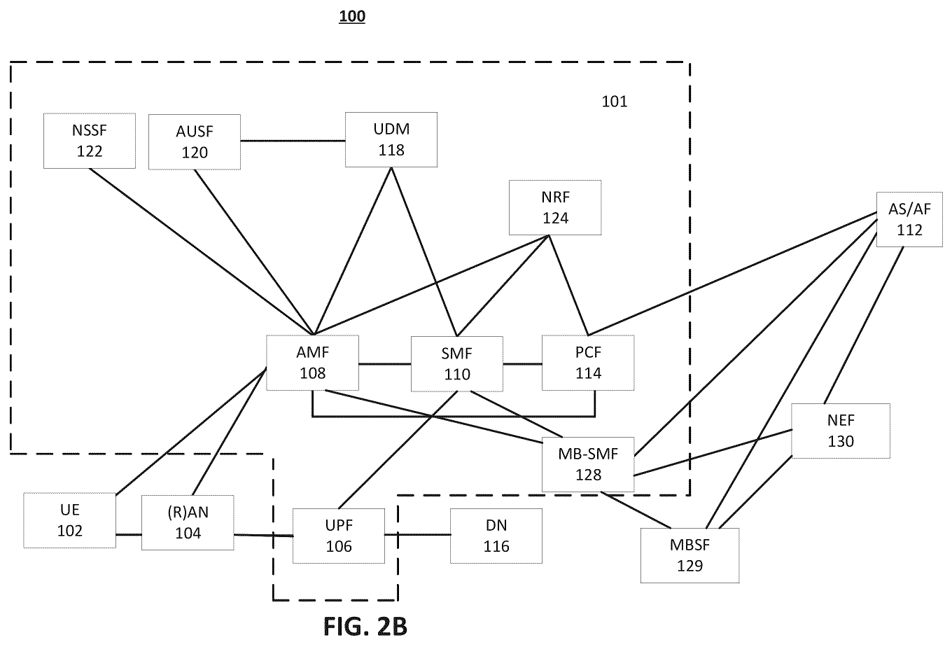

Apparatus 10 of FIG. 1 is one example of an apparatus for a communications system such as the communication system 100 shown in FIGS. 2A-2B and described in further detail below. The apparatus 10 that may be configured as a network entity and/or a network function of the communication system 100. In some embodiments, the apparatus 10 may be UE 102.

As shown in FIG. 1, the apparatus 10 includes processing circuity 20 (generally referred to herein as a processor), a memory device 60 (generally referred to herein as memory), and a communication interface 40. The processing circuitry 20 may be in communication with the memory device 60 via a bus for passing information between the processing circuitry 40 and the memory 60 of the apparatus 10. The memory 60 may be non-transitory and may include, for example, one or more volatile and/or non-volatile memories. In other words, for example, the memory device 60 may be an electronic storage device (e.g., a computer readable storage medium) comprising gates configured to store data (e.g., bits) that may be retrievable by a machine (e.g., a computing device like the processing circuitry). The memory device 60 may be configured to store information, data, content, applications, instructions, or the like for enabling the apparatus to carry out various operations in accordance with an example embodiment of the present disclosure. For example, the memory device 60 could be configured to buffer input data for processing by the processing circuitry 20. Additionally or alternatively, the memory device 60 could be configured to store instructions for execution by the processing circuitry 20.

The apparatus 10 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single “system on a chip.” As such, in some cases, a chip or chipset may constitute means for performing one or more operations for providing the functionalities described herein. The apparatus 10, in some embodiments, may be computing device, such as a standalone computer, a distributed computing system, or a cloud computing system. For example, the apparatus 10 may be for the core network 102 and may comprise one or more of the network functions of the core network 102.

The processing circuitry 20 may be embodied in a number of different ways. For example, the processing circuitry 20 may be embodied as one or more of various hardware processing means such as a coprocessor, a microprocessor, a controller, a Digital Signal Processor (DSP), a processing element with or without an accompanying DSP, or various other circuitry including integrated circuits such as, for example, an Application Specific Integrated Circuit (ASIC), a Field Programmable Gate Array (FPGA), a Microcontroller Unit (MCU), a central processing unit (CPU), a multi-core CPU, a graphic processing unit (GPU), a tensor processing unit (TPU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processing circuitry 20 may be configured to execute instructions stored in the memory device 60 or otherwise accessible to the processing circuitry 20. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processing circuitry 20 is embodied as an executor of instructions, the instructions may specifically configure the processor to perform the algorithms and/or operations described herein when the instructions are executed. However, in some cases, the processing circuitry 20 may be a processor of a specific device (e.g., an image or video processing system) configured to employ an embodiment of the present disclosure by further configuration of the processing circuitry by instructions for performing the algorithms and/or operations described herein. The processing circuitry 20 may include, among other things, a clock, an Arithmetic Logic Unit (ALU) and logic gates configured to support operation of the processing circuitry.

The communication interface 40 may be any means such as a device or circuitry embodied in either hardware or a combination of hardware and software that is configured to receive and/or transmit data, including media content in the form of video or image files, one or more audio tracks or the like. In this regard, the communication interface 40 may include, for example, an antenna (or multiple antennas) and supporting hardware and/or software for enabling wireless communications. Additionally or alternatively, the communication interface may include the circuitry for interacting with the antenna(s) to cause transmission of wireless or radio signals via the antenna(s) or to handle receipt of wireless or radio signals received via the antenna(s). In some environments, the communication interface may alternatively or also support wired communication. As such, for example, the communication interface may include a communication modem and/or other hardware/software for supporting communication via cable, Digital Subscriber Line (DSL), Universal Serial Bus (USB) or other mechanisms.

The apparatus 10 may implement certain example embodiments and/or components thereof disclosed herein.

FIGS. 2A-2B illustrate various examples a mobile network 100 comprising a user equipment 102 connected to an application server 112 via a radio access network 104 and core network 101 (which together form a communication system) and a data network 116. In some embodiments, the mobile network 100 can comprise any suitable configuration, number, orientation, positioning, and/or dimensions of components and specialized equipment configured to provide an air interface (e.g., New Radio (NR)) for communication or connection between a User Equipment 102 (UE 102) and a Data Network 116 (DN 116) via a Core Network 101 (CN 101) of the communications system. As illustrated in FIG. 2A, a mobile network 100 can be provided in which the UE 102 is in operable communication with a 5G Access Network (5G-AN) (e.g., (R)AN 104). In some embodiments, UE 102 may be in operable communication with another access network (AN) (not shown) which connects UE 102 to the core network 101. Examples of other ANs include Wireline Access network terminated at a W-AGF or an Untrusted Non 3GPP access Network terminated at a N3IWF) An access network may include one or more base stations, an access points, access network nodes, and/or the like. In some embodiments, the 5G access network (5G-RAN) 104 can communicate with the CN 101 or a network entity or network function thereof using reference points. In some embodiments, the CN 101 can provide a data connection (e.g., PDU session) between the UE 102 and the DN 116, such as for sending data, messages, requests, and/or the like.

The RAN 104 may comprise a plurality of RAN nodes, such as Next Generation Radio Access Network (NG-RAN) nodes 104a (not shown in FIG. 2A), for providing connectivity to one or more UE 102 to the core network 101. The NG-RAN node 104a may comprise a gNB, NG-eNB, and/or the like, and provides NR access to UE 102s in its service area. It will be appreciated that where embodiments are described in conjunction with 5G-AN (e.g., RAN), R(AN), NG-RAN, and 5G, other types of access networks may be developed in the future.

In some embodiments, the DN 116 or the CN 101 can be in communication with an Application Server (AS) or Application Function (AF) 112 hosed on the AS). The (R)AN 104, CN 101, DN 116, and/or AS/AF 112 can be associated with a Network Repository Function (NRF) 124,, Secure Copy Protocol (SCP), Security Edge Protection Proxy (SEPP), Policy Control Function (PCF) 114, the like, or any combination thereof.

In the context of a mobile network, such as the mobile network illustrated in FIG. 2B, the communications network 100 can comprise a series of connected network devices and specialized hardware that is distributed throughout a service region, state, province, city, or country, and one or more network entities, which can be stored at and/or hosted by one or more of the connected network devices or specialized hardware. In some embodiments, the UE 102 can connect to the (R)AN 104, which can then relay the communications between the UE 102 and the CN 101, the CN 101 being connected to the DN 116, which can be in communication with one or more AS (or AF 112 hosted on the AS). In some embodiments, the UE 102 can be in communication with a (R)AN 104 depicting any 5G-AN, which can act as a relay between the UE 102 and other components or services of the CN 101. For instance, in some embodiments, the UE 102 can communicate with the (R)AN 104, which can in turn communicate with an Access and Mobility Management Function 108 (AMF 108). In other instances or embodiments, the UE 102 can communicate directly with the AMF 108. In some embodiments, the AMF 108 can be in communication with one or more network functions (NFs), such as an Authentication Server Function 120 (AUSF 120), a Network Slice Selection Function 122 (NSSF 122), a Network Repository Function 124 (NRF 124), a Policy Control Function 114 (PCF 114), a Network Data Analytics Function 126 (NWDAF 126), a Unified Data Management function 118 (UDM 118), the AS/AF 112, a Session Management Function 110 (SMF 110), and/or the like using service based interfaces.

The (R)AN 104 may also be configured to communicate with the Multicast/Broadcast-Session Management Function 128 (MB-SMF 128). The MB-SMF 128 maintains downstream nodes based on responses from AMF 108. In some embodiments, the MB-SMF128 establishes shared tunnels for the user plane entity. The MB-SMF may be configured to perform various functions relating to requesting, and responding regarding the creation of MBS sessions, and/or subscribing to and/or notifying entities regarding supported MBS services.

In another embodiment once the AF 112 subscribes to Delivery Status Indication, the MB-SMF 128 informs the AF 112 about various conditions that are affecting Multicast/Broadcast Service (MBS) session delivery via the NEF and MBSF. The (R)AN 104 may broadcast Temporary Mobile Group Identity (TMGI) to represent the MBS service over the radio interface. Additional (R)ANs may be configured to report successful MBS Session establishment, and the AMF 108 may communicate with the MB-SMF 128 through various messages in order to indicate statuses of an MBS session.

According to certain embodiments, during the establishment of an MBS session, the AF 112 subscribes at the MB-SMF 128 to receive notifications about areas where MBS broadcast is not supported. The AMF 108, when handling requests to start or update the MBS broadcast session, checks if the one or more (R)AN nodes supporting the service area are configured to support MBS broadcast. If one or more areas are not supported, the AMF 108 notifies the MB-SMF 128 and the AF 112 that one or more areas are not supported and indicates the one or more areas in the notification. In response to the notification, the MB-SMF 128 combines the one or more areas where MBS broadcast is not supported and notifies the AF 112. The AF 112 may be configured to determine whether to deliver data via unicast to UEs in the one or more areas that are unsupported or establish an MBS multicast session instead.

The Multicast/Broadcast Service Function 129 (MBSF) and/or Network Exposure Function 130 (NEF) as shown in FIG. 2B. The NEF 130 is configured to perform various functions to support MBS sessions. The NEF 130 may provide an interface to the AF 112 to perform MBS procedures (e.g., service provisioning, MBS session management, etc.). The NEF 130 may also communicate with the AF 112 to determine transport parameters and perform session operations. In some embodiments, the NEF 130 may be configured to select a particular MB-SMF to serve an MBS session. The NEF 130 may also be configured to provision MBS session assistance information for the purpose of receiving MBS session data.

The MBSF 130 is configured to perform various functions to support MBS sessions. The MBSF 130 communicates with the AF 112 and MB-SMF 128 to perform MBS session operations. The MBSF 130 may also communicate with these entities to perform session transport and to determine transport parameters. In some embodiments, the NEF 130 may be configured to select a particular MB-SMF to serve an MBS session.

In certain embodiments, the NEF/MBSF 129 and 130 and/or MB-SMF 128 compare one or more MBS service areas indicated in a request from the AF 112 with information about one or more areas supporting MBS broadcast in the (R)AN 104. If parts, or one or more sub-areas, of the service area do not support MBS broadcast, the NEF/MBSF 129 and 130 and/or MB-SMF 128 indicates this to the AF 112 in a reply to the AF request. Responsive to the reply, the AF 112 may determine whether to send data via unicast to users in unsupported regions, terminate the MBS broadcast session, or submit a new request to the NEF/MBSF 129 and 130 and/or MB-SMF 128 with a reduced service area.

In some embodiments, the SMF 110 can be in communication with one or more User Plane Functions 106 (UPF 106, UPF 106a, UPF 106b, collectively “UPF 106”). By way of example only, in some embodiments, the UPF 106 can be in communication with the (R)AN 104 and the DN 116. In other embodiments, the DN 116 can be in communication with a first UPF 106a and the (R)AN 104 can be in communication with a second UPF 106b, while the SMF 110 is in communication with both the first and second UPFs 106a, b and the first and second UPFs 106a, b are in communication each with the other.

In some embodiments, the UE 102 can comprise a single-mode or a dual-mode device such that the UE 102 can be connected to one or more (R)ANs 104. In some embodiments, the (R)AN 104 can be configured to implement one or more Radio Access Technologies (RATs), such as Bluetooth, Wi-Fi, and Global System for Mobile Communications (GSM), Universal Mobile Telecommunications Service (UMTS), LTE or 5G NR, among others, that can be used for communicating with the UE 102 and the CN 101. In some embodiments, the (R)AN 104 can implement one or more base stations, for control plane communications between the UE 102 and the AMF 108 of the CN 101.

In some embodiments, the mobile network 100 or components thereof (e.g., base stations, towers, etc.) can be configured to communicate with a communication device (e.g., the UE 102) such as a cell phone or the like over multiple different frequency bands, e.g., FR1 (below 6 GHZ), FR2 (mm Wave), other suitable frequency bands, sub-bands thereof, and/or the like. In some embodiments, the communications network 100 can comprise or employ massive Multiple Input and Multiple Output (massive MIMO) antennas. In some embodiments, the UE 102 and/or the RAN 104 can comprise multi-user MIMO (MU-MIMO) antennas. In some embodiments, the communications network 100 can employ edge computing whereby computing systems of the data network 116 are communicatively, physically, computationally, and/or temporally closer to the communications system (e.g., the UPF of the core network 101) in order to reduce latency and data traffic congestion. In some embodiments, the RAN 104 can employ other technologies, devices, or techniques, such as small cell, low-powered RAN, beamforming of radio waves, WIFI-cellular convergence, Non-Orthogonal Multiple Access (NOMA), channel coding, and the like.

It will be appreciated that certain example embodiments described herein arise in the context of a telecommunications network, including but not limited to a telecommunications network that conforms to and/or otherwise incorporates aspects of a 5th generation (5G) architecture. While FIGS. 2A-2B illustrate various configurations and/or components of an example architecture of the communications network 100, many other systems, system configurations, networks, network entities, and pathways/protocols for communication therein are contemplated and considered within the scope of this present disclosure.

While the methods, devices/apparatuses, and computer program products/codes described herein are described within the context of a 5th generation core network (5GC) and system, such as illustrated in FIGS. 2A-2B and described hereinabove, the described methods, devices, and computer program products can nevertheless be applied in a broader context within any suitable telecommunications system, network, standard, and/or protocol. It will be appreciated that the described methods, devices, and computer program products can further be applied to yet undeveloped future networks and systems as would be apparent to one skilled in the art in light of the present disclosure.

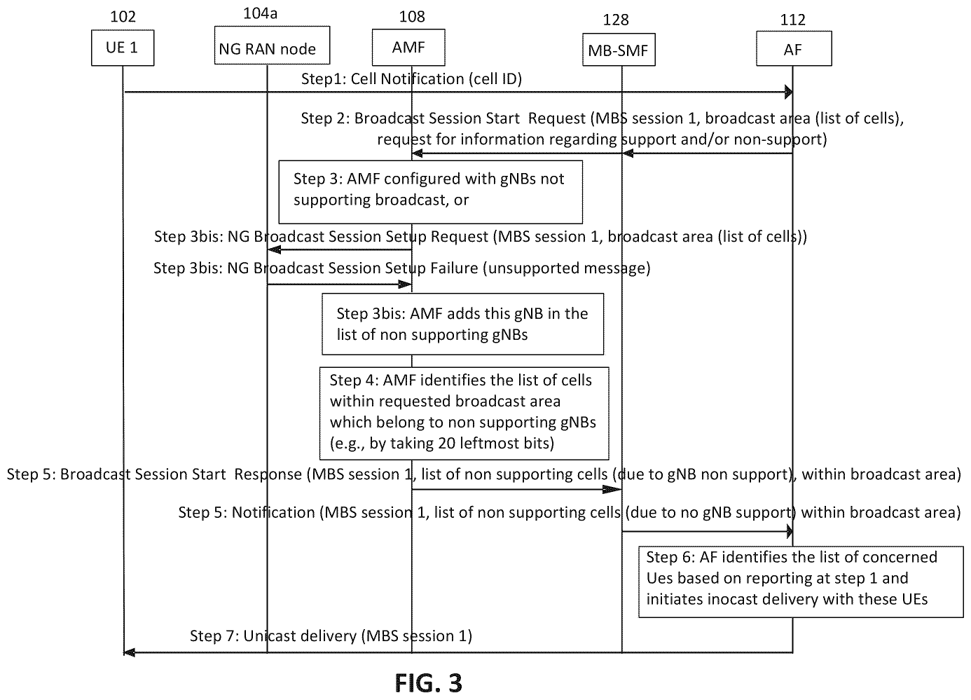

FIG. 3 is an example message flow according to certain example embodiments. As shown in FIG. 3, The AMF may determine whether NG-RAN nodes support 5MBS broadcast such as by one or more of the following non-limiting examples:
Via a capability indicator received from the RAN nodes when they set up a connection to the AMF
Via configuration of RAN node capabilities, e.g. via Operations, Administration and Maintenance (OAM) system
Via error responses when sending signaling to start an MBS broadcast session to the RAN node

The AMF may determine parts, or sub-areas, of the MBS service area that are served by RAN nodes not supporting MBS broadcast such as by one or more of the following non-limiting examples:
If the service area is denoted via cell IDs, via the part of the cell IDs that denote the RAN node.
If the service area is denoted via tracking areas, via configured knowledge of the tracking areas served by a RAN node.
Via configuration of RAN node service areas, e.g. via OAM. Configured information is required for tracking areas served by some RAN nodes supporting MBS broadcast and other RAN nodes not supporting MBS broadcast.

When receiving the notification, the AF may identify UEs that subscribed to the MBS session and are residing in parts, or sub-areas, of the MBS service area where MBS broadcast is not supported, and send data related to the MBS session via unicast delivery to those UEs. establish an MBS multicast session instead of the MBS broadcast session. The AF can also send a new MBS session modification request with a service area reduced to the parts, or sub-areas, where MBS broadcast is supported.

Alternatively, the AF may terminate the MBS broadcast session and establish an MBS multicast session instead of the MBS broadcast session.

In Operation 1 of FIG. 3, UE 1 sends a Cell Notification (cell ID) to AF 112.

In Operation 2 of FIG. 3, a Broadcast Session Start Request (MBS session 1, broadcast area (list of cells), request for information regarding support and/or non-support) is transmitted by AF 112 to AMF 108 via MB-SMF 128.

In Operation 3 of FIG. 3, AMF 108 is configured with one or more NG-RAN nodes not supporting broadcast, or

Operation 3b is of FIG. 3 begins with AMF 108 sending an NG Broadcast Session Setup Request (MBS session 1, broadcast area (list of cells)) to NG-RAN node 104. Then NG-RAN node 104 sends a NG Broadcast Session Setup Failure (unsupported message) in response to the request sent by AMF 108. AMF 108 adds NG-RAN node 104 to the list of non supporting NG-RAN nodes.

In Operation 4 of FIG. 3, AMF 108 identifies the list of cells within requested broadcast area which belong to non supporting NG-RAN node 104 (e.g., by taking 20 leftmost bits).

In Operation 5 of FIG. 3, a Broadcast Session Start Response (MBS session 1, list of non supporting cells (due to NG-RAN node non support), within broadcast area) is sent by AMF 108 to MB-SMF 128. Then MB-SMF 128 sends a Notification (MBS session 1, list of non supporting cells (due to no NG-RAN node support) within broadcast area) to AF 112.

In Operation 6 of FIG. 3, AF 112 identifies the list of concerned UEs based on reporting at Operation 1 and initiates unicast delivery with these UEs.

In Operation 7 of FIG. 3, AF 112 transmits a Unicast delivery (MBS session 1) to UE 102.

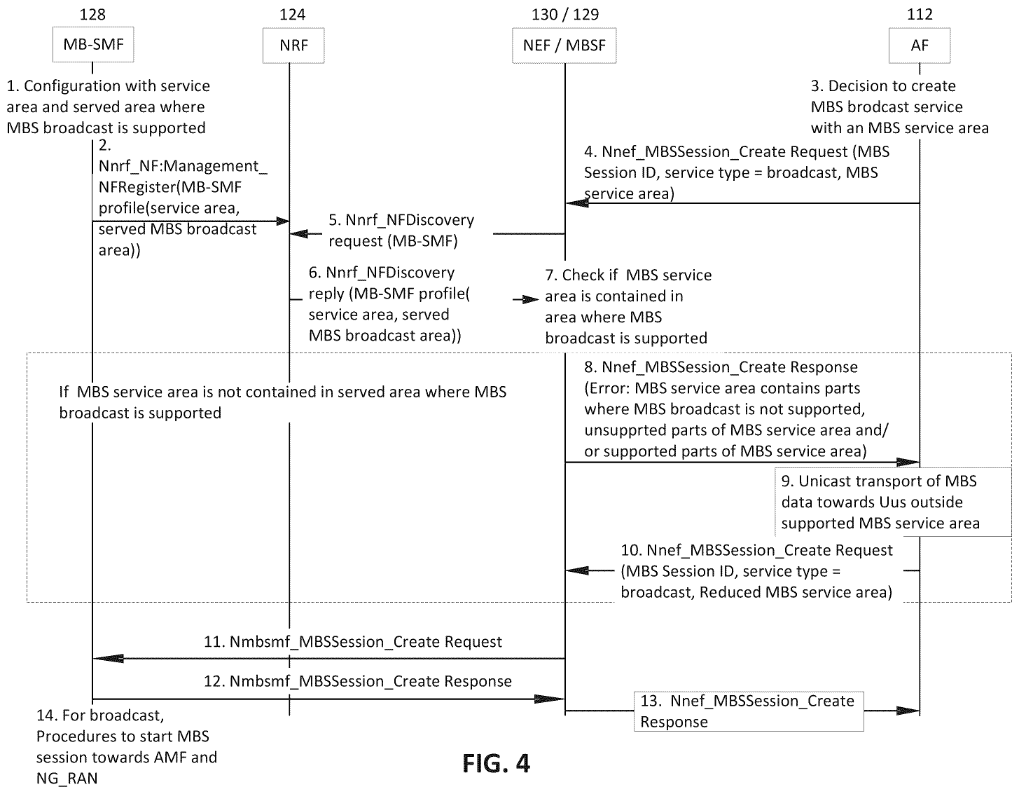

FIG. 4 is an example message flow according to certain example embodiments.

According to FIG. 4, MB-SMF is configured (e.g. via OAM) with a service area it serves and in addition with the parts, or sub-areas, of that service area where MBS broadcast is supported. MB-SMF stores this information (including the parts, or sub-areas, of that service area where MBS broadcast is supported) as part of its profile in the NRF.

NEF retrieves MB-SMF profiles (including the parts, or one or more sub-areas, of that service area where MBS broadcast is supported) from NRF to discover MB-SMFs, e.g. triggered by the creation of an MBS session.

When receiving an MBS session create request from an AF for an MBS broadcast session, NEF/MBSF compares MBS service area received in the request with the service area of MB-SMFs and the parts, or one or more sub-areas, of that service area where MBS broadcast is supported of MB-SMFs, as retrieved from the NRF. If at least parts, or one or more sub-areas, of the requested MBS service area are not contained in the parts, or one or more sub-areas, of the service area where MBS broadcast is supported in any of the MB-SMF profile(s), the NEF/MBSF sends an error response to the create request to the AF, and indicates as error cause that the requested MBS service area contains parts, or one or more sub-areas, where the MBS broadcast service is not supported, and indicates unsupported parts, or one or more sub-areas, of MBS service area and/or supported parts, or one or more sub-areas, of MBS service area. The NEF/MBSF only performs that check for MBS broadcast sessions, but not for MBS multicast sessions. The NEF/MBSF may check in addition whether the requested service area matches the service area of a single MB-SMF, and otherwise provide an error response indicating that the service area is too large and an acceptable service area that can be served by a single MB-SMF. Both errors can be provided in combination.

When receiving the reply, the AF may identify UEs that subscribed to the MBS session and are residing in parts, or one or more sub-areas, of the original MBS service area where MBS broadcast is not supported, and send data related to the MBS session via unicast delivery to those UEs. The AF can also send a new MBS session establishment request with a service area reduced to the parts, or one or more sub-areas, where MBS broadcast is supported. Alternatively, the AF may establish an MBS multicast session instead of the MBS broadcast session.

As shown in FIG. 4, in Operation 1, MB-SMF 128 is configured with service area and served area where MBS broadcast is supported.

In Operation 2, MB-SMF 128 transmits a Nnrf_NF: Management_ NFRegister (MB-SMF profile (service area, served MBS broadcast area)) to NRF 124.

In Operation 3, AF 112 determines to create MBS broadcast service with an MBS service area.

In Operation 4, AF 112 sends a Nnef_MBSSession_Create Request (MBS Session ID, service type=broadcast, MBS service area) to NEF 130 and/or MBSF 129.

In Operation 5, NEF/MBSF 130 and 129 transmits a Nnrf_NFDiscovery request (MB-SMF) to NRF 124.

In Operation 6, a Nnrf_NFDiscovery reply (MB-SMF profile (service area, served MBS broadcast area)) is sent by NRF 124 to NEF 130 and/or MBSF 129.

In Operation 7, AF 112 checks if MBS service area is contained in area where MBS broadcast is supported.

In the case that MBS service area is not contained in served area where MBS broadcast is supported, operations 8-10 are performed. In Operation 8, AF 112 transmits a nef_MBSSession_Create Response (Error: MBS service area contains parts, or one or more sub-areas, where MBS broadcast is not supported, unsupported parts, or one or more unsupported sub-areas, of MBS service area and/or supported parts or sub-area of MBS service area) to NEF/MBSF 130 and 129.

In Operation 9, AF 112 performs a Unicast transport of MBS data towards UEs outside supported MBS service area.

In Operation 10, AF 112 sends a Nnef_MBSSession_Create Request (MBS Session ID, service type=broadcast, Reduced MBS service area) to NEF/MBSF 130 and 129.

In the case that MBS service area is contained in served area where MBS broadcast is supported, the process continues with operation 11. In Operation 11, NEF/MBSF 130 and 129 sends a Nmbsmf_MBSSession_Create Request NRF 124.

In Operation 12, NRF 124 transmits a Nmbsmf_MBSSession_Create Response back to NEF/MBSF 130 and 129.

In Operation 13, NEF/MBSF 130 and 129 sends a Nnef_MBSSession_Create Response to AF 112.

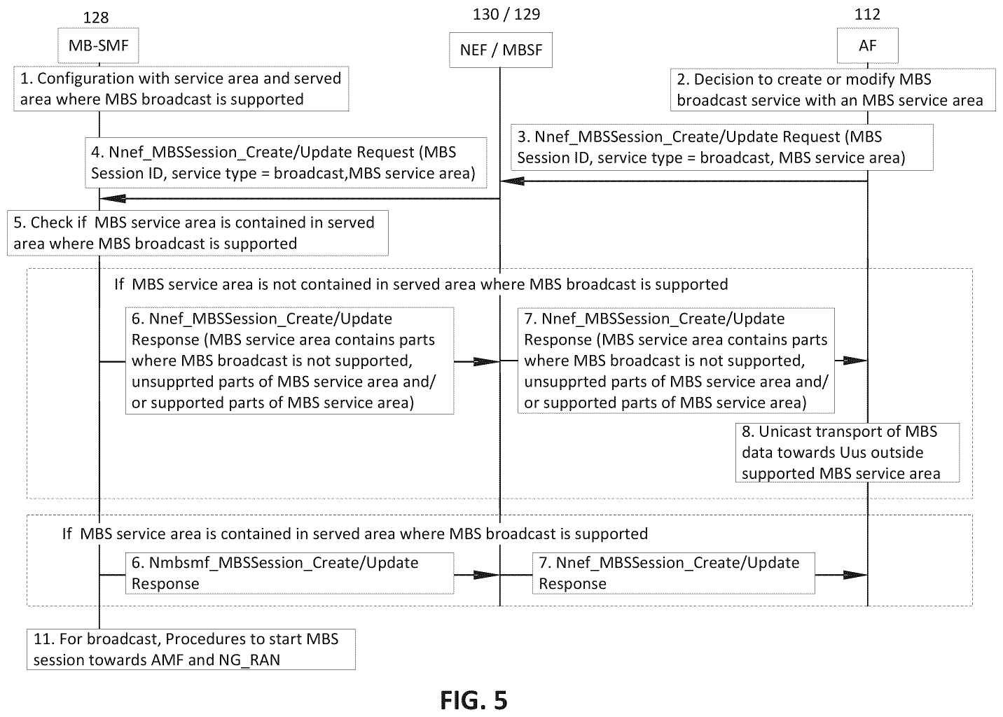

FIG. 5 is an example message flow according to certain example embodiments.

MB-SMF is configured (e.g. via OAM) with a service area it serves and in addition with the parts, or one or more sub-areas, of that service area where MBS broadcast is supported.

When receiving an MBS session create or update request from an AF (possibly via NEF/MBSF) for an MBS broadcast session, MB-SMF compares the MBS service area received in the request with the parts, or one or more sub-areas, of that service area where MBS broadcast is supported. If at least parts, or one or more sub-areas, of the requested MBS service area are not contained in the parts, or one or more sub-areas, of the service area where MBS broadcast is supported, the MB-SMF indicates in the response to the create or update request that the requested MBS service area contains parts, or one or more sub-areas, where the MBS broadcast service is not supported, and indicates unsupported parts, or one or more sub-areas, of MBS service area and/or supported parts, or one or more sub-areas, of MBS service area. The MB-SMF only performs that check for MBS broadcast sessions, but not for MBS multicast sessions. The MB-SMF may check in addition whether the requested service area matches the service area it serves, and otherwise provide an indication that the service area is too large and an acceptable service area that can be served by a single MB-SMF. Both indications can be provided in combination.

When receiving the reply, the AF may identify UEs that subscribed to the MBS session and are residing in parts of the original MBS service area where MBS broadcast is not supported, and send data related to the MBS session via unicast delivery to those UEs. Alternatively, the AF may terminate the MBS broadcast session and establish an MBS multicast session instead of the MBS broadcast session.

In Operation 1 of FIG. 5, MB-SMF 128 is configured with service area and served area where MBS broadcast is supported.

In Operation 2 of FIG. 5, AF 112 determines to create or modify MBS broadcast service with an MBS service area.

In Operation 3 of FIG. 5, AF 112 sends a Nnef_MBSSession_Create/Update Request (MBS Session ID, service type=broadcast, MBS service area) to NEF/MBSF 130 and 129.

In Operation 4 of FIG. 5, NEF/MBSF 130 and 129 transmits a Nnef_MBSSession_Create/Update Request (MBS Session ID, service type=broadcast, MBS service area) to MB-SMF 128.

In Operation 5 of FIG. 5, MB-SMF 128 checks if MBS service area is contained in served area where MBS broadcast is supported.

In the case that MBS service area is not contained in served area where MBS broadcast is supported, operations 6-8 of FIG. 5 in the indicated dashed box are performed before Operation 11. In Operation 6, a Nnef_MBSSession_Create/Update Response (MBS service area contains parts where MBS broadcast is not supported, unsupported parts of MBS service area and/or supported parts of MBS service area) is sent from MB-SMF 128 to NEF/MBSF 130 and 129.

In Operation 7 of FIG. 5, NEF/MBSF 130 and 129 sends the Nnef_MBSSession_Create/Update Response (MBS service area contains parts where MBS broadcast is not supported, unsupported parts of MBS service area and/or supported parts of MBS service area) to AF 112.

In Operation 8 of FIG. 5, AF 112 performs a Unicast transport of MBS data towards UEs outside supported MBS service area.

In the case that MBS service area is contained in served area where MBS broadcast is supported, operations 6-7 of FIG. 5 in the indicated dashed box are performed before

Operation 11 of FIG. 5. In Operation 6, a Nmbsmf_MBSSession_Create/Update Response is sent from MB-SMF 128 to NEF/MBSF 130 and 129.

In Operation 7 of FIG. 5, NEF/MBSF 130 and 129 sends the Nnef_MBSSession_Create/Update [symbol] Response to AF 112.

In Operation 11 of FIG. 5, MB-SMF 128 performs, for broadcast, procedures to start MBS session towards AMF and NG_RAN.

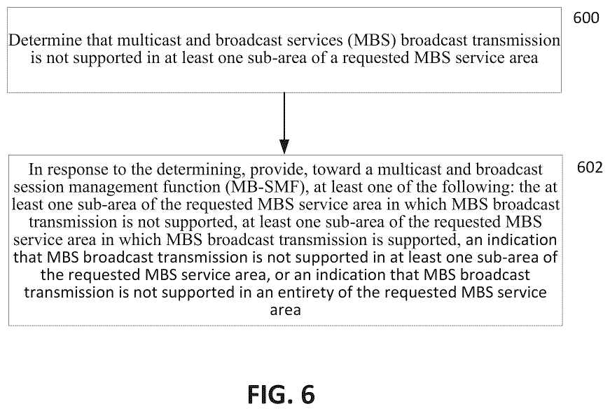

FIG. 6 illustrates operations that may be performed by an access and mobility function (AMF) according to certain example embodiments, such as by an apparatus 10 embodied by an AMF 108.

As shown by operation 600, apparatus 100 embodied by a network entity, such as an AMF 108, includes means, such as processing circuity 20, memory 60, and/or the like, for determining that multicast and broadcast services (MBS) broadcast transmission is not supported in at least one sub-area of a requested MBS service area.

As shown by operation 602, apparatus 100 embodied by a network entity, such as an AMF 108, includes means, such as processing circuity 20, communication interface 40, memory 60, and/or the like, for in response to the determining, providing, toward a multicast and broadcast session management function (MB-SMF), at least one of the following: the at least one sub-area of the requested MBS service area in which MBS broadcast transmission is not supported, at least one sub-area of the requested MBS service area in which MBS broadcast transmission is supported, an indication that MBS broadcast transmission is not supported in at least one sub-area of the requested MBS service area, or an indication that MBS broadcast transmission is not supported in an entirety of the requested MBS service area.

Apparatus 100 embodied by a network entity, such as an AMF 108, includes means, such as processing circuity 20, communication interface 40, memory 60, and/or the like, for receiving, from the MB-SMF, an MBS session start request comprising a request for information regarding the support of MBS broadcast transmission in the MBS service area, wherein the determining and the providing is performed in response thereto.

Apparatus 100 embodied by a network entity, such as an AMF 108, includes means, such as processing circuity 20, communication interface 40, memory 60, and/or the like, for receiving, from a next generation radio access network (NG-RAN) node, an MBS capability indicator. Apparatus 100 embodied by a network entity, such as an AMF 108, includes means, such as processing circuity 20, memory 60, and/or the like, for storing the MBS capability indicator in association with at least one of: an identifier of the NG-RAN node, an area served by the NG-RAN node, or an area comprising the area served by the NG-RAN node, wherein the determining is based on at least the MBS capability indicator.

The determining of operation 600 may include, such as with processing circuity 20, communication interface 40, memory 60, and/or the like, sending a request to an NG-RAN node to start MBS broadcast transmission or setup a broadcast context, receiving a response to the request, the response comprising an error indicating that at least one of MBS broadcast transmission or the setup of the broadcast context is not supported, and storing an indication that MBS broadcast transmission is not supported, in association with at least one of an identifier of the NG-RAN node, an area served by the NG-RAN node, or an area comprising the area served by the NG-RAN node.

The determining of operation 600 may include, such as with processing circuity 20, communication interface 40, memory 60, and/or the like, based on the stored one or more configurations for MBS broadcast transmission, comparing an area served by the one or more NG-RAN nodes associated with the requested MBS service area, and determining whether or not MBS broadcast transmission is supported by the one or more NG-RAN nodes.

The determining of operation 600 may include, such as with processing circuity 20, communication interface 40, memory 60, and/or the like, determining a first set of NG-RAN node IDs corresponding to NG-RAN node serving cells of the requested MBS service area, deriving a second set of NG-RAN node IDs corresponding to at least one of: the NG-RAN nodes of the first set which do not support MBS broadcast transmission according to stored information, or the NG-RAN nodes of the first set which support the MBS broadcast transmission according to stored information, and performing at least one of determining the at least one sub-area of the requested MBS service area in which the MBS broadcast transmission is not supported from the second set of NG-RAN nodes which do not support MBS broadcast transmission, or determining the at least one sub-area of the requested MBS service area in which the MBS broadcast transmission is supported from the second set of NG-RAN nodes which support MBS broadcast transmission.

The determining of operation 600 may include, such as with processing circuity 20, communication interface 40, memory 60, and/or the like, determining a NG-RAN node ID of the first set by taking a predetermined number of leftmost bits of cell IDs of cells comprised in the requested MBS service area, determining the at least one sub-area of the requested MBS service area in which the MBS broadcast transmission is not supported by identifying the cells for which the cell ID has the predetermined number of leftmost bits corresponding to one of the NG-RAN node IDs of the second set of NG-RAN node IDs, or determining the at least one sub-area of the requested MBS service area in which the MBS broadcast transmission is supported by identifying the cells for which the cell ID has the predetermined number of leftmost bits corresponding to one of the NG-RAN node IDs of the second set of NG-RAN node IDs.

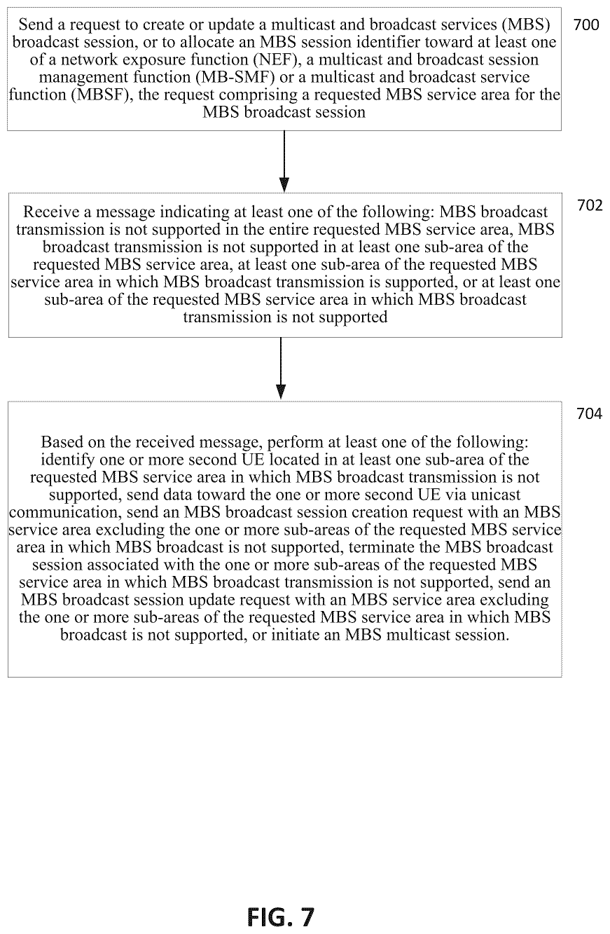

FIG. 7 illustrates operations that may be performed by an application function (AF) according to certain example embodiments, such as by an apparatus 10 embodied by an AF 112.

As shown by operation 700, apparatus 100 embodied by a network entity, such as an AF, includes means, such as processing circuity 20, communication interface 40, memory 60, and/or the like, for sending a request to create or update a multicast and broadcast services (MBS) broadcast session, or to allocate an MBS session identifier toward at least one of a network exposure function (NEF), a multicast and broadcast session management function (MB-SMF) or a multicast and broadcast service function (MBSF), the request comprising a requested MBS service area for the MBS broadcast session.

As shown by operation 702, apparatus 100 embodied by a network entity, such as an AF 112, includes means, such as processing circuity 20, communication interface 40, memory 60, and/or the like, for receiving a message indicating at least one of the following: MBS broadcast transmission is not supported in the entire requested MBS service area, MBS broadcast transmission is not supported in at least one sub-area of the requested MBS service area, at least one sub-area of the requested MBS service area in which MBS broadcast transmission is supported, or at least one sub-area of the requested MBS service area in which MBS broadcast transmission is not supported.

As shown by operation 704, apparatus 100 embodied by a network entity, such as an AF 112, includes means, such as processing circuity 20, communication interface 40, memory 60, and/or the like, for based on the received message, performing at least one of the following: identify one or more second UE located in at least one sub-area of the requested MBS service area in which MBS broadcast transmission is not supported; send data toward the one or more second UE via unicast communication, send an MBS broadcast session creation request with an MBS service area excluding the one or more sub-areas of the requested MBS service area in which MBS broadcast is not supported, terminate the MBS broadcast session associated with the one or more sub-areas of the requested MBS service area in which MBS broadcast transmission is not supported, send an MBS broadcast session update request with an MBS service area excluding the one or more sub-areas of the requested MBS service area in which MBS broadcast is not supported, or initiate an MBS multicast session.

According to certain embodiments, apparatus 100 embodied by a network entity, such as an AF 112, includes means, such as processing circuity 20, communication interface 40, memory 60, and/or the like, for receiving (a) information about at least one user equipment (UE) desiring to receive the MBS broadcast session, and (b) a UE location of the at least one UE.

According to certain embodiments, apparatus 100 embodied by a network entity, such as an AF 112, includes means, such as processing circuity 20, memory 60, and/or the like, for, based on the received message and the UE location of the at least one UE, identifying one or more second UE located in at least one sub-area of the requested MBS service area in which MBS broadcast transmission is not supported.

According to certain embodiments, apparatus 100 embodied by a network entity, such as an AF 112, includes means, such as processing circuity 20, communication interface 40, memory 60, and/or the like, for sending data toward the one or more second UE via unicast communication. According to certain embodiments, the data that is sent via unicast communication is transmitted as MBS data in the one or more sub-areas of the requested MBS sub-area in which MBS broadcast transmission is supported.

The received message, such as of operation 702, may be a notification message, and certain example embodiments, such as AF 112 with processing circuitry 20 may subscribe for information regarding the support of MBS broadcast transmission in the MBS service area.

The received message, such as of operation 702, may be a response to the request sent to create or update an MBS broadcast session from the at least one of the NEF, the MB-SMF or the MBSF.

The AF 112, such as with processing circuitry 20, and/or the like may send an MBS broadcast session creation request with an MBS service area excluding the one or more sub-areas of the requested MBS service area in which MBS broadcast is not supported, and/or terminate an MBS broadcast session associated with the one or more sub-areas of the requested MBS service area in which MBS broadcast transmission is not supported.

The AF 112, such as with processing circuitry 20, and/or the like may send an MBS broadcast session update request with an MBS service area excluding the one or more sub-areas of the requested MBS service area in which MBS broadcast is not supported. The AF 112, such as with processing circuitry 20, and/or the like may initiate a multicast session comprising a multicast service area which comprises the at least one sub-area of the requested MBS service area in which the MBS broadcast transmission is not supported.

According to certain embodiments, apparatus 100 embodied by a network entity, such as an AF 112, includes means, such as processing circuity 20, communication interface 40, memory 60, and/or the like, for receiving (a) information about at least one user equipment (UE) desiring to receive the MBS broadcast session, and (b) a UE location of the at least one UE, based on the received message and the UE location of the at least one UE, identifying the one or more second UE.

According to certain embodiments, the request to initiate the MBS multicast session comprises the requested MBS service area or a second MBS service area which comprises the at least one sub-area of the requested MBS service area in which the MBS broadcast transmission is not supported

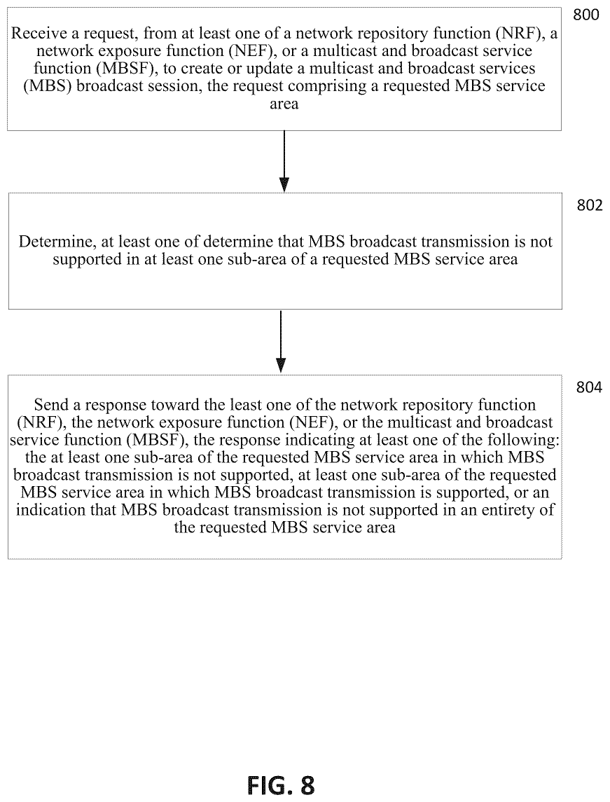

FIG. 8 illustrates of operations that may be performed by a multicast and broadcast session management function (MB-SMF) according to certain example embodiments,, such as by an apparatus 10 embodied by an MB-SMF.

As shown by operation 800, apparatus 100 embodied by a network entity, such as an MB-SMF 128, includes means, such as processing circuity 20, communication interface 40, memory 60, and/or the like, for receiving a request, from at least one of a network repository function (NRF), a network exposure function (NEF), or a multicast and broadcast service function (MBSF), to create or update a multicast and broadcast services (MBS) broadcast session, the request comprising a requested MBS service area.

As shown by operation 802, apparatus 100 embodied by a network entity, such as an MB-SMF 128, includes means, such as processing circuity 20, memory 60, and/or the like, for determining, at least one of determine that MBS broadcast transmission is not supported in at least one sub-area of a requested MBS service area.

As shown by operation 804, apparatus 100 embodied by a network entity, such as an MB-SMF 128, includes means, such as processing circuity 20, communication interface 40, memory 60, and/or the like, for sending a response toward the least one of the network repository function (NRF), the network exposure function (NEF), or the multicast and broadcast service function (MBSF), the response indicating at least one of the following: the at least one sub-area of the requested MBS service area in which MBS broadcast transmission is not supported, at least one sub-area of the requested MBS service area in which MBS broadcast transmission is supported, or an indication that MBS broadcast transmission is not supported in an entirety of the requested MBS service area. The response may be sent in response to the request to create or update the MBS broadcast session.

According to certain embodiments, apparatus 100 embodied by a network entity, such as an MB-SMF 128, includes means, such as processing circuity 20, communication interface 40, memory 60, and/or the like, for sending a request to start or update an MBS broadcast session to an access and mobility management function (AMF), the request comprising a second requested MBS service area, wherein the second requested MBS service area comprises the requested MBS service area or at least one sub-area of the requested MBS service area, and receiving from the AMF a message indicating at least one of that MBS broadcast transmission is not supported in the entire second requested MBS service area, that MBS broadcast transmission is supported in the entire second requested MBS service area at least one sub-area of the second requested MBS service area where MBS broadcast transmission is supported, or at least one sub-area of the second requested MBS service area where MBS broadcast transmission is not supported. The MB-SMF 128, includes means, such as processing circuity 20, memory 60, and/or the like, for determining the sub-area of the requested MBS service area where MBS broadcast transmission is not supported using the message received from the AMF.

According to certain embodiments, apparatus 100 embodied by a network entity, such as an MB-SMF 128, includes means, such as processing circuity 20, communication interface 40, memory 60, and/or the like, for receiving a configuration about at least one of an area where MBS broadcast transmission is supported or an area where MBS broadcast transmission is not supported, wherein the determining that MBS broadcast transmission is not supported in at least one sub-area of a requested MBS service area is based on the configuration.

According to certain embodiments, apparatus 100 embodied by a network entity, such as an MB-SMF 128, includes means, such as processing circuity 20, communication interface 40, memory 60, and/or the like, for requesting a network resource function (NRF) to store within profile information of the apparatus at least one of information about an area served by the apparatus in which MBS broadcast transmission is supported or information about an area served by the apparatus in which MBS broadcast transmission is not supported, wherein the determining that MBS broadcast transmission is not supported in at least one sub-area of a requested MBS service area is based on the configuration.

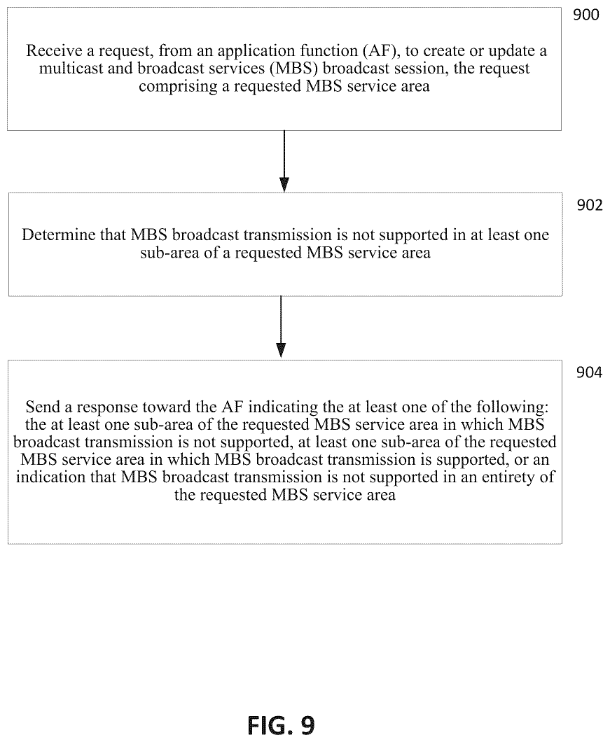

FIG. 9 illustrates operations that may be performed by at least one of a network exposure function (NEF), or a multicast and broadcast service function (MBSF), according to certain example embodiments, such as by an apparatus 10 embodied by an MBSF.

As shown by operation 900, apparatus 100 embodied by a network entity, such as an NEF 130 and/or MBSF 129, includes means, such as processing circuity 20, communication interface 40, memory 60, and/or the like, for receiving a request, from an application function (AF), to create or update a multicast and broadcast services (MBS) broadcast session, the request comprising a requested MBS service area.

As shown by operation 902, apparatus 100 embodied by a network entity, such as an NEF 130 and/or MBSF 129, includes means, such as processing circuity 20, memory 60, and/or the like, for determining that MBS broadcast transmission is not supported in at least one sub-area of a requested MBS service area.

As shown by operation 904, apparatus 100 embodied by a network entity, such as an NEF 130 and/or MBSF 129, includes means, such as processing circuity 20, communication interface 40, memory 60, and/or the like, for sending a response toward the AF indicating the at least one of the following: the at least one sub-area of the requested MBS service area in which MBS broadcast transmission is not supported, at least one sub-area of the requested MBS service area in which MBS broadcast transmission is supported, or an indication that MBS broadcast transmission is not supported in an entirety of the requested MBS service area. The response may be sent in response to the request to create or update the MBS broadcast session.

Apparatus 100 embodied by a network entity, such as an NEF 130 and/or MBSF 129, includes means, such as processing circuity 20, communication interface 40, memory 60, and/or the like, for retrieving, from a network repository function (NRF), profile information of at least one multicast and broadcast session management function (MB-SMF) comprising at least one of information about an area served by the MB-SMF in which MBS broadcast transmission is supported or information about an area served by the MB-SMF in which MBS broadcast transmission is not supported, wherein the determining is based on the retrieved profile information.

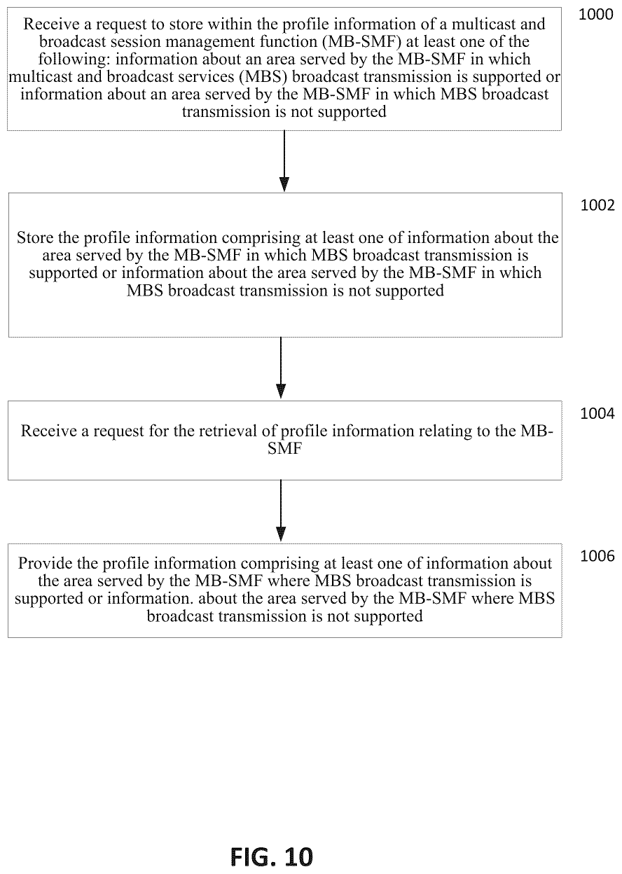

FIG. 10 illustrates operations that may be performed by a network repository function (NRF) function according to certain example embodiments, such as by an apparatus 10 embodied by an NRF.

As shown by operation 1000, apparatus 100 embodied by a network entity, such as an NRF 124, includes means, such as processing circuity 20, communication interface 40, memory 60, and/or the like, for receiving a request to store within the profile information of a multicast and broadcast session management function (MB-SMF) at least one of the following: information about an area served by the MB-SMF in which multicast and broadcast services (MBS) broadcast transmission is supported or information about an area served by the MB-SMF in which MBS broadcast transmission is not supported.

As shown by operation 1002, apparatus 100 embodied by a network entity, such as an NRF 124, includes means, such as processing circuity 20, memory 60, and/or the like, for storing the profile information comprising at least one of information about the area served by the MB-SMF in which MBS broadcast transmission is supported or information about the area served by the MB-SMF in which MBS broadcast transmission is not supported.

As shown by operation 1004, apparatus 100 embodied by a network entity, such as an NRF 124, includes means, such as processing circuity 20, communication interface 40, memory 60, and/or the like, for receiving a request for the retrieval of profile information relating to the MB-SMF.

As shown by operation 1006, apparatus 100 embodied by a network entity, such as an NRF 124, includes means, such as processing circuity 20, communication interface 40, memory 60, and/or the like, for providing the profile information comprising at least one of information about the area served by the MB-SMF where MBS broadcast transmission is supported or information. about the area served by the MB-SMF where MBS broadcast transmission is not supported.

Some figures herein illustrate message flows, signal flows, and/or call flows according to an example embodiment of the present disclosure. It will be understood that each block of the figure may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 60 of an apparatus 10 employing an embodiment of the present disclosure and executed by a processing circuity 20. As will be appreciated, any such computer program instructions may be loaded onto a computer or other programmable apparatus (for example, hardware) to produce a machine, such that the resulting computer or other programmable apparatus implements the functions specified in the figures. These computer program instructions may also be stored in a computer-readable memory that may direct a computer or other programmable apparatus to function in a particular manner, such that the instructions stored in the computer-readable memory produce an article of manufacture the execution of which implements the function specified in the figures. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the figures.

Accordingly, blocks of the figures and message flows, call flows, and/or signal diagrams support combinations of means for performing the specified functions and combinations of operations for performing the specified functions for performing the specified functions. It will also be understood that one or more blocks of the figures, and combinations of blocks in the figures, can be implemented by special purpose hardware-based computer systems which perform the specified functions, or combinations of special purpose hardware and computer instructions.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims.

Moreover, although the foregoing descriptions and the associated drawings describe certain example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

Although several variations have been described in detail above, other modifications or additions are possible. Further features and/or variations may be provided in addition to those set forth herein. Moreover, the implementations described above may be directed to various combinations and sub-combinations of the disclosed features and/or combinations and sub-combinations of several further features disclosed above. Other embodiments may be within the scope of the following claims.

If desired, the different functions discussed herein may be performed in a different order and/or concurrently with each other. Furthermore, if desired, one or more of the above-described functions may be optional or may be combined. Although various aspects of some of the embodiments are set out in the independent claims, other aspects of some of the embodiments comprise other combinations of features from the described embodiments and/or the dependent claims with the features of the independent claims, and not solely the combinations explicitly set out in the claims. It is also noted herein that while the above describes certain example embodiments, these descriptions should not be viewed in a limiting sense. Rather, there are several variations and modifications that may be made without departing from the scope of some of the embodiments as defined in the appended claims. Other embodiments may be within the scope of the following claims. The term “based on” includes “based on at least.” The use of the phase “such as” means “such as for example” unless otherwise indicated.

It should therefore again be emphasized that the various embodiments described herein are presented by way of illustrative example only and should not be construed as limiting the scope of the claims. For example, alternative embodiments can utilize different communication system configurations, user equipment configurations, base station configurations, identity request processes, messaging protocols and message formats than those described above in the context of the illustrative embodiments. These and numerous other alternative embodiments within the scope of the appended claims will be readily apparent to those skilled in the art.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

1-19. (canceled)

20. An apparatus comprising:
at least one processor; and
at least one memory comprising instructions of a network exposure function (NEF) or a multicast and broadcast service function (MBSF), wherein the instructions when executed by the at least one processor, cause the apparatus to at least perform:
receiving, from an application function (AF), a request to create a multicast and broadcast services (MBS) broadcast session, the request comprising an indication of a requested MBS service area;
based on determining that MBS broadcast transmission is not supported in a sub-area of the requested MBS service area, sending a response to the request toward the AF, the response comprising an indication that MBS broadcast transmission is not supported in an entirety of the requested MBS service area.

21. The apparatus of claim 20, wherein the instructions, when executed by the at least one processor, further cause the apparatus to at least perform:
retrieve, from a network repository function (NRF), profile information of at least one multicast and broadcast session management function (MB-SMF), the profile information comprising information about an area served by the MB-SMF in which MBS broadcast transmission is supported, wherein the determining is based on the profile information.

22. The apparatus of claim 20, wherein the instructions, when executed by the at least one processor, further cause the apparatus to at least perform:
retrieve, from a network repository function (NRF), profile information of at least one multicast and broadcast session management function (MB-SMF), the profile information comprising information about an area served by the MB-SMF in which MBS broadcast transmission is not supported, wherein the determining is based on the profile information.

23. A method comprising:
receiving, at a network exposure function (NEF) or a multicast and broadcast service function (MBSF), a request, from an application function (AF), a request to create a multicast and broadcast services (MBS) broadcast session, the request comprising an indication of a requested MBS service area; and
based on determining, at the NEF that received the request or the MBSF that received the request, that MBS broadcast transmission is not supported in at least one sub-area of a requested MBS service area, sending, by the NEF that received the request or MBSF that received the request, a response toward the AF, the response comprising an indication that MBS broadcast transmission is not supported in an entirety of the requested MBS service area.

24. The method of claim 23, further comprising:
retrieving, by the NEF that received the request or MBSF that received the request, from a network repository function (NRF), profile information of at least one multicast and broadcast session management function (MB-SMF), the profile information comprising information about an area served by the MB-SMF in which MBS broadcast transmission is supported, wherein the determining is based on the retrieved profile information.

25. The method of claim 23, further comprising:
retrieving, by the NEF that received the request or MBSF that received the request, from a network repository function (NRF), profile information of at least one multicast and broadcast session management function (MB-SMF), the profile information comprising information about an area served by the MB-SMF in which MBS broadcast transmission is not supported, wherein the determining is based on the retrieved profile information.

26. A non-transitory computer-readable storage medium comprising instructions of a network exposure function (NEF) or a multicast and broadcast service function (MBSF), wherein the instructions, when executed by at least one processor of an apparatus, cause the apparatus to perform:
receiving a request, from an application function (AF), to create a multicast and broadcast services (MBS) broadcast session, the request comprising an indication of a requested MBS service area; and
based on determining that MBS broadcast transmission is not supported in a sub-area of the requested MBS service area, sending a response to the request toward the AF, the response comprising an indication that MBS broadcast transmission is not supported in an entirety of the requested MBS service area.

27. The non-transitory computer-readable storage medium of claim 26, wherein the instructions, when executed by the at least one processor, further cause the apparatus to at least perform:
retrieving, from a network repository function (NRF), profile information of at least one multicast and broadcast session management function (MB-SMF), the profile information comprising information about an area served by the MB-SMF in which MBS broadcast transmission is supported, wherein the determining is based on the retrieved profile information.

28. The non-transitory computer-readable storage medium of claim 26, wherein the instructions, when executed by the at least one processor, further cause the apparatus to at least perform:
retrieving, from a network repository function (NRF), profile information of at least one multicast and broadcast session management function (MB-SMF), the profile information comprising information about an area served by the MB-SMF in which MBS broadcast transmission is not supported, wherein the determining is based on the retrieved profile information.
